(19) United States
(12) Patent Application Publication
(10) Pub. No.: US 2022/0376542 A1
(43) Pub. Date: Nov. 24, 2022

(54) WIRELESS CHARGING CONTROL METHOD, WIRELESS CHARGER AND WIRELESS CHARGING SYSTEM

(71) Applicant: NINGBO WEIE ELECTRONICS TECHNOLOGY LTD., Ningbo (CN)

(72) Inventors: Lizhi XU, Ningbo (CN); Lulu SONG, Ningbo (CN); Weiyi FENG, Ningbo (CN); Feng YU, Ningbo (CN)

(73) Assignee: NINGBO WEIE ELECTRONICS TECHNOLOGY LTD., Ningbo (CN)

(21) Appl. No.: 17/729,356

(22) Filed: Apr. 26, 2022

(30) Foreign Application Priority Data
May 19, 2021 (CN) 202110546433.7

(51) Int. Cl. H02J 7/00; H02J 7/34; H02J 50/10; H02J 50/90

(52) U.S. Cl. CPC H02J 7/007192; H02J 7/34; H02J 50/10; H02J 50/90; H02J 7/0068

(57) ABSTRACT

Disclosed in embodiments of the present disclosure are a wireless charging control method and a wireless charging system. An electricity transmitter is controlled to charge a chargeable device in the discontinuous mode in response to the temperature information matches the first preset condition. In the discontinuous mode, electricity transmitter is controlled to charge the chargeable device during first charging time period of each charging cycle, and to stop charging the chargeable device during second charging time period of each charging cycle to let an energy storage element in the chargeable device discharge to a battery. Thus, it is possible to reduce the power consumption caused by magnetic induction in the wireless charging process, to lower the temperature of the electricity transmitter and the chargeable device, and to reduce the wake-up times of the chargeable device during the charging process.

### CLAIM OF PRIORITY AND CROSS-REFERENCE TO RELATED APPLICATION(S)

This application claims the benefit of Chinese Patent Application No. 202110546433.7, filed on May 19, 2021, entitled “wireless charging control method, wireless charger and wireless charging system”, which is incorporated herein by reference in its entirety.

### BACKGROUND OF THE DISCLOSURE

### 1. Field of the Disclosure

The present disclosure relates to the field of wireless charging, and particularly to a wireless charging control method, a wireless charger and a wireless charging system.

### 2. Description of the Related Art

As the requirements for charging power of electricity transmitter in wireless charger are rising, electricity transmitter and the chargeable device (such as: mobile phones) are provided with increasing power consumption which will exist in the form of heat, so as to cause the electricity transmitter and the chargeable device have higher charging temperature and lower charging efficiency. At present, forced air cooling or metal cooling is usually used to reduce the temperature of the electricity transmitter, and the temperature of the electricity transmitter and the chargeable device can also be reduced by reducing the magnetic field generated by the electricity transmitter or controlling the electricity transmitter to stop charging, when the temperature is too high. Wherein, the most effective cooling way is to control the electricity transmitter to stop charging the chargeable device when the charging temperature is too high.

However, in this cooling mode, the electricity transmitter will stop charging when the charging temperature is too high, so when the temperature drops to a certain level, the chargeable device needs to be waked up for continue charging. At the same time, in order to ensure that users realize the charging process, a charging notice will be sent to users after the chargeable device restores to charging state. The whole process is too complicated. In addition, frequent discharges and recharges will damage the performance of the chargeable device and affect the user's charging experience.

### BRIEF DESCRIPTION OF THE DISCLOSURE

In view of the existing status, embodiments of the present disclosure provide a wireless charging control method, a wireless charger and a wireless charging system, to reduce the charging temperature in the process of wireless charging, reduce the wake-up times of the chargeable device, so as to avoid damage to the chargeable device and improve user experience.

In a first aspect, embodiments of the present disclosure provide a wireless charging control method, comprising: obtaining temperature information during charging process; and charging a chargeable device in discontinuous mode in response to the temperature information matches first preset condition. In the discontinuous mode, electricity transmitter is controlled to charge the chargeable device during first charging time of each charging cycle, electricity storage element is arranged to charge the chargeable device during second charging time of each charging cycle.

In some embodiments, the method further comprising: in response to the temperature information doesn't match the first preset condition, charging the chargeable device in continuous mode, in which the electricity transmitter is controlled to charge the chargeable device continuously.

In some embodiments, the method further comprising: obtaining position parameter of the chargeable device, which are determined based on the coil quality factor of the electricity transmitter; and determining intensity of magnetic field generated by the electricity transmitter based on the position parameter.

In some embodiments, the method further comprising: determining the first charging time and the second charging time.

In some embodiments, the determining the first charging time and the second charging time further comprising: obtaining model information of the chargeable device; determining minimum charging energy based on the model information, the minimum charging energy represents electricity value to maintain the charging state of the chargeable device; and determining the duration of the first charging time period and the duration of the second charging time period based on the minimum charging energy. The minimum charging energy represents electricity value to maintain the charging state of the chargeable device.

In some embodiments, the determine the first charging time and the second charging time further comprising: determining a first charging time threshold based on minimum charging energy and intensity of magnetic field generated by the electricity transmitter; determining the duration of the first charging time period based on the first charging time threshold; determining a second charging time threshold based on the minimum charging energy; and determining the second charging time based on the second charging time threshold. The minimum charging energy represents quantity of electric charge to maintain the charging state of the chargeable device. The first charging time threshold represents time for charging the energy storage element to a state with the minimum charging energy under the present magnetic field intensity. The second charging time threshold represents time for discharging the energy storage element to maintain the chargeable device in charging state.

In some embodiments, the method further comprising: the electricity storage element is disposed in the chargeable device.

In some embodiments, the obtaining temperature information during charging process comprising: obtaining the temperature information at preset intervals.

In some embodiments, the temperature information includes charging power and/or charging temperature obtain by sampling. The charging temperature represents the temperature of the electricity transmitter and/or the chargeable device collected during charging.

In some embodiments, the charging power is transmitted from the chargeable device to the electricity transmitter in a message-based manner.

In some embodiments, the first preset condition is that the charging power is less than or equal to a preset power value or the charging temperature is greater than or equal to a preset temperature value.

In a second aspect, embodiments of the present disclosure provide a wireless charger, the wireless charger comprising: an electricity transmitter configured to generate magnetic field to charge a chargeable device; and a processor, configured to perform operations according to method described in the first aspect.

In a third aspect, embodiments of the present disclosure provide a wireless system comprising the wireless charger described in the second aspect.

Disclosed in embodiments of the present disclosure are a wireless charging control method and a wireless charging system. An electricity transmitter is controlled to charge a chargeable device in the discontinuous mode in response to the temperature information matches the first preset condition. In the discontinuous mode, electricity transmitter is controlled to charge the chargeable device during first charging time period of each charging cycle, and to stop charging the chargeable device during second charging time period of each charging cycle to let an energy storage element in the chargeable device discharge to a battery. Thus, it is possible to reduce the power consumption caused by magnetic induction in the wireless charging process, to lower the temperature of the electricity transmitter and the chargeable device, and to reduce the wake-up times of the chargeable device during the charging process.

### BRIEF DESCRIPTION OF THE DRAWINGS

Through the following description of the embodiments of the present disclosure with reference to the drawings, the above and other objectives, features and advantages of the present disclosure will become more apparent, wherein:

FIG. 1 is a first flow diagram of the wireless charging control method according to the embodiments of the present disclosure;

FIG. 2 is a second flow chart of the wireless charging control method according to the embodiments of the present disclosure;

FIG. 3 is a third flow chart of the wireless charging control method according to the embodiments of the present disclosure;

FIG. 4 is a flow chart for determining magnetic field intensity according to the embodiments of the present disclosure;

FIG. 5 is the fourth flow chart of the wireless charging control method according to the embodiments of the present disclosure;

FIG. 6 is a flow chart for determining the first charging time and the second charging time according to the embodiments of the present disclosure;

FIG. 7 is a schematic diagram of charging process for the chargeable device according to the embodiments of the present disclosure;

FIG. 8 is a schematic diagram of the wireless charger according to the embodiments of the present disclosure;

FIG. 9 is a schematic diagram of the wireless charging system according to the embodiments of the present disclosure.

### DETAILED DESCRIPTION OF EMBODIMENTS OF THE DISCLOSURE

The present disclosure is described below on the basis of the embodiments, but is not merely limited to these embodiments. Specific details are described in detail in the following detailed description of the present disclosure. The present disclosure can also be fully understood by a person skilled in the art without the description of the details. In order to avoid confusing the essence of the present disclosure, commonly known method, process, flow, element and circuit are not described in detail.

In addition, a person skilled in the art should understand that the drawings herein are provided for the purpose of description only, and are not necessarily drawn in proportion.

Unless otherwise stated, the terms “comprise”, “include” and the like in the entire application document shall be interpreted as inclusive rather than exclusive or exhaustive; in other words, the terms mean “include but not limited to”.

In the descriptions of the present disclosure, it should be understood that the terms like “first”, “second” and the like are used for the purpose of description only, but cannot be considered to indicate or imply relative importance. In addition, in the descriptions of the present disclosure, unless otherwise stated, the meaning of “a plurality of” is two or more.

The power consumption generated in the process of wireless charging exists in the form of heat, which causes the increasing of the charging temperature of the electricity transmitter and the chargeable device, and reducing of the charging efficiency. Therefore, method should be taken to cool the charging process down when the chargeable device is overheated during the charging process. Common cooling methods are as follows:

1, Forced air cooling or metal cooling. For example, a fan is installed in the electricity transmitter to force convection heat exchange, so as to achieve the effect of forced air cooling for the electricity transmitter. Or the metal such as aluminum or zinc alloy can be used to make the bottom shell of the electricity transmitter, for transmitting the heat the external of the electricity transmitter through the metal bottom shell, so as to achieve the cooling effect. However, when the electricity transmitter and the chargeable device are having long-distance charge there between, in order to ensure the charging effect, the electricity transmitter needs to generate more energy, which causes additional eddy-current loss and heat on the chargeable device to be charged. At this point, the heat of the chargeable device cannot be dissipated through the fan or metal shell of the electricity transmitter, and causing non-ideal cooling effect.

2, Reduce the magnetic field intensity. By reducing the magnetic field intensity, the magnetic field intensity generated by the electricity transmitter can be reduced, and the charging power and eddy-current loss of the chargeable device are also reduced. However, due to the accumulative effect of heat, although the charging temperature decreases slowly, the charging speed decreases.

3, Stop charging for a while. When the charging temperature is over the limit, the electricity transmitter can stop charging the chargeable device for a period of time, until the temperature of the electricity transmitter and the chargeable device drops to a certain line, and then restores to the normal charging mode. In this way, by reducing the magnetic field intensity of the electricity transmitter to zero, the electricity transmitter and the chargeable device can be rapidly cooled. However, when the temperature drops, the chargeable device needs to be waked up to resume charging and send corresponding charging notice to the user, causing a complicate process. In addition, frequent charging interruption and waking up will also affect the performance of the chargeable device and the user's charging experience.

Based on the above content, embodiments of the present disclosure provide a wireless charging control method, a wireless charger and a wireless charging system, to reduce the charging temperature of the electricity transmitter and the chargeable device in the process of wireless charging, so as to reduce the wake-up times of the chargeable device, avoid damage to the chargeable device and improve user experience.

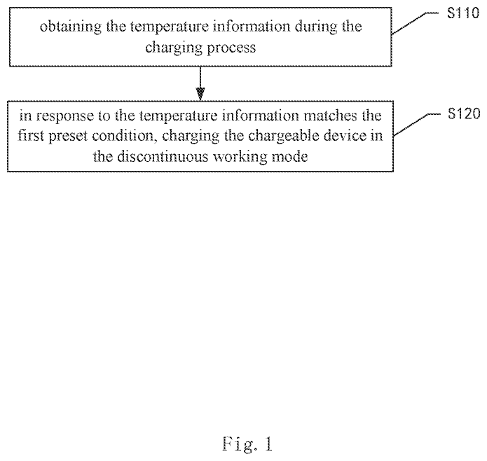

FIG. 1 is the first flow diagram of the wireless charging control method according to the embodiments of the present disclosure. As shown in FIG. 1, the wireless charging control method of the embodiments includes the following steps:

S110, obtaining the temperature information during the charging process.

S120, in response to the temperature information matches the first preset condition, charging the chargeable device in the discontinuous mode.

In the present embodiment, in the discontinuous mode, the electricity transmitter is controlled to charge the chargeable device during a first charging time period of each charging cycle, and to stop charging the chargeable device during second charging time period of each charging cycle to make an energy storage element in the chargeable device discharge to a battery which is disposed in the chargeable device.

The technical scheme of the embodiments of the disclosure discontinuously charging the chargeable device by obtaining the temperature information in the charging process in response to the temperature information matches first preset condition. In the discontinuous mode, the electricity transmitter is controlled to charge the chargeable device during the first charging time of each charging cycle. In the second charging time period of each charging cycle, the electricity transmitter is controlled to stop working so that the electricity storage element which is charged with energy during the first charging time period is utilized to charge the battery of the chargeable device. Therefore, through the electricity transmitter and energy storage element alternately charge the battery of the chargeable device, the continuous generation of magnetic field of the electricity transmitter during the charging process can be avoided, so as to reduce the power consumption causing by the magnetic sensation, increase the cooling speed of the electricity transmitter and the chargeable device, thus reduce the charging temperature of the electricity transmitter and the chargeable device. At the same time, it may reduce times the chargeable device waked up during the charging process and avoid damage to the chargeable device caused by frequent charging interruption, which may improve the user experience.

It should be understood that the energy storage element may be a capacitance and/or inductance in the wireless power receiver circuit of the chargeable device which electrically coupled with the battery of the chargeable device. Specifically, the energy storage element may be a capacitance set in the resonant circuit of the power receiver.

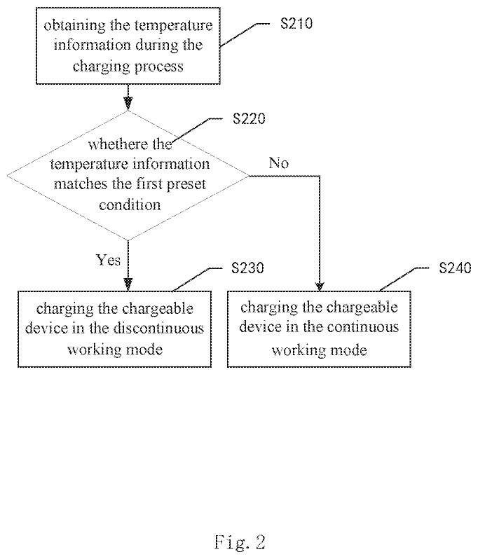

FIG. 2 is the second flow chart of the wireless charging control method according to the embodiments of the present disclosure. As shown in FIG. 2, the wireless charging control method of the embodiments includes the following steps:

S210, obtaining the temperature information during the charging process.

Optionally, the temperature information is obtained at preset intervals in the present embodiment. Thus, the temperature information may be periodically obtained by preset timing, so as to facilitate getting the temperature information during the charging process, so that when there appear anomalies, the charging temperature may be adjusted to normal charging status as soon as possible, to avoid reducing the charging efficiency of the chargeable device, even damaging to the chargeable device caused by high temperature.

Optionally, the temperature information in the present embodiment includes the charging power and/or the sampled charging temperature. Wherein, charging power refers to the power transmitted by the electric energy emitter to the chargeable device or the input power received by the chargeable device. Charging temperature is used to represent the temperature of the electricity transmitter and/or the chargeable device collected during the charging process.

Further, the temperature information in the present embodiment can be the charging power. Specifically, the charging power refers to the input power received by the chargeable device. The charging power is transmitted to the electricity transmitter by the chargeable device in a message-based manner.

It should be understood that as the charging process progresses, the charging temperature of the corresponding electricity transmitter and the chargeable device will rise, and the output power from the electricity transmitter to the chargeable device and the input power of the chargeable device will decrease. Therefore, the temperature change in the charging process can be obtained by detecting the charging power.

Further, the temperature information in the present embodiment may be the charging temperature of the electricity transmitter or the temperature of the chargeable device sampled under the charging state. Optionally, temperature information may be sampled by the thermocouple in the electricity transmitter or the chargeable device.

S220, Whether the temperature information matches the first preset condition is determined. If yes, to S230. If no, to S240.

Optionally, the first preset condition in the present embodiment is that the charging power is less than or equal to the preset power value, or the charging temperature is greater than or equal to the preset temperature value. The preset power value and the preset temperature value are set according to the actual charging control process, respectively as the corresponding power value and temperature value when there appears over-temperature in the charging progress, or as the corresponding power value and temperature value when there will appear over-temperature in the charging progress according to the changing trend of the charging power or the charging temperature.

In the present embodiment, the preset power value may be determined according to the historical charging records. Optionally, the preset power value can be determined based on the power corresponding to the average charging time. For example, assuming that the average charging time of the chargeable device is 2 hours in the historical charging record, the preset power value shall be determined based on the power that the chargeable device consumes within 2 hours. Optionally, the preset temperature value may be determined according to the preset power value, that is, the temperature when the charging power reaches the preset power value during the charging process. It should be understood that the preset power value and the preset temperature value may also be determined by other implementation methods, such as determined based on the actual application scenarios or defined according to experience, which is not restricted in the present embodiment.

In the present embodiment, if the charging power is less than or equal to the preset power value, it is indicated that over-temperature may occur, the charging efficiency decreases, and the temperature information matches the first preset condition. When the charging power is greater than the preset power value, it indicates that the charging efficiency of the chargeable device is in normal condition, there is no over-temperature appears, and the temperature information does not match the first preset condition.

Alternatively, if the sampled temperature of the electricity transmitter is greater than or equal to the preset temperature value, it is indicated that there occurs over-temperature, the charging efficiency decreases, and the temperature information matches the first preset condition. If the sampled temperature of the electricity transmitter is less than the preset temperature value, it indicates that the charging efficiency of the chargeable device is in normal condition, there occurs no over-temperature, and the temperature information does not match the first preset condition.

S230, in response to the temperature information matches the first preset condition, the chargeable device is charged in the discontinuous mode.

In the present embodiment, the discontinuous mode is adopted to charge the chargeable device when the charging power is less than or equal to the preset power value or the charging temperature is greater than or equal to the preset temperature value. In the discontinuous mode, the electricity transmitter is controlled to charge the chargeable device during the first charging time period of each charging cycle, and stop working during the second charging time period of each charging cycle, so as to let the energy storage element be discharged to release power to the battery of the chargeable device, which maintain the battery in a charging state.

Optionally, in the present embodiment, the electricity transmitter is controlled to charge the energy storage element and the battery of the chargeable device during the first charging time period of each charging cycle. Furthermore, the energy storage element may be an energy storage capacitor, which is arranged in the chargeable device. Thus, in the first charging time period of each charging cycle, the electricity transmitter is controlled to charge the battery of the chargeable device and the energy storage capacitor in the chargeable device, so that the energy storage capacitor can be used to charge the chargeable device later in the second charging time period.

At the same time, due to the charging power that the energy storage element output is far less than electricity transmitter, the heat generation can be reduced based on the premise that the constantly charging state of the chargeable device may be maintained, which speeds up the cooling of chargeable device and the electricity transmitter, reduces the temperature, and decreases the wake-up times of the chargeable device and message-sending times to the user at the same time, so as to simplify the charging process, avoid damage to the chargeable device, improve the charging efficiency of the chargeable device and the user experience.

Optionally, the present embodiment adopts the discontinuous mode to charge the chargeable device. Firstly, the electricity transmitter is controlled the chargeable device to charging the chargeable device and energy storage capacitor during the first charging time period, to ensure that later in the second charging time period, the power stored the energy storage capacitor may provide enough energy to the chargeable device, so as to maintain a charging state until the next charging cycle, which avoid the chargeable device to enter into the uncharged status. Therefore, the present embodiment may reduce the temperature in the charging process, as the battery of the chargeable device is continuously charged. Furthermore, the loss of the chargeable device is reduced, and the charging efficiency and user experience are improved.

S240, in response to the temperature information doesn't match the first preset condition, the electricity transmitter charges the chargeable device in the continuous mode.

In the present embodiment, if the charging power is greater than the preset power value or the charging temperature is less than the preset temperature value, it is indicated that there appears no over-temperature situation at present, so that the chargeable device is charged in a continuous mode. In the continuous mode, the electricity transmitter generates a magnetic field has preset intensity and charges the chargeable device. Therefore, if the charging temperature is in normal range, the charging rate of the chargeable device can be ensured, which can improve the charging experience of users.

It should be understood that charging the chargeable device in continuous mode may start at the beginning of the charging process, or after the over-temperature condition is occurred and cooling is realized by switching to the discontinuous mode. In the present embodiment, the temperature information is obtained at every preset interval time, i.e., the temperature information is obtained periodically, so that when the influence of over-temperature is removed, the chargeable device may be restored to be charged in time, which can improve the charging efficiency.

Optionally, in the present embodiment, the electricity transmitter is also controlled to charge the energy storage element in the chargeable device while charging the chargeable device in continuous mode. Therefore, if the over-temperature situation appears during the charging process, the discontinuous work mode need to be adopted for charging. During the second charging time period of each charging cycle, the electricity transmitter is controlled to stop working so that the battery of the chargeable device is charged by the energy stored in the energy storage capacitor. Therefore, the heat generated in the process of charging is reduced, the cooling of the system is speed up, and the charging efficiency of the charging system is improved.

The embodiments of the present disclosure obtain the temperature information during charging process, in response to the temperature information matches the first preset condition, charging chargeable device in the discontinuous mode, in the discontinuous mode, controlling the electricity transmitter to charge the chargeable device during the first charging time of each charging cycle, arranging the electricity storage element to charge the chargeable device during the second charging time of each charging cycle. Therefore, the heat generated in the second charging time can be reduced by the charging process of the electricity storage element, so as to reduce the heat generation of each charging circle, and speed up cooling process, which can improve the charging efficiency of the chargeable device. In addition, when there is no over-temperature appears in the charging process, the continuous mode is adopted to control the electricity transmitter to charge the chargeable device, so as to improve the charging efficiency and speed up the charging process. At the same time, the continuous mode controls the electricity transmitter to charge energy storage component, facilitating the charging process directly into the second charging time when the over-temperature occurs, so as to reduce the heat generation between the transition of the first charging time to the second charging time, further speed up the cooling process, improve the charging efficiency of the chargeable device.

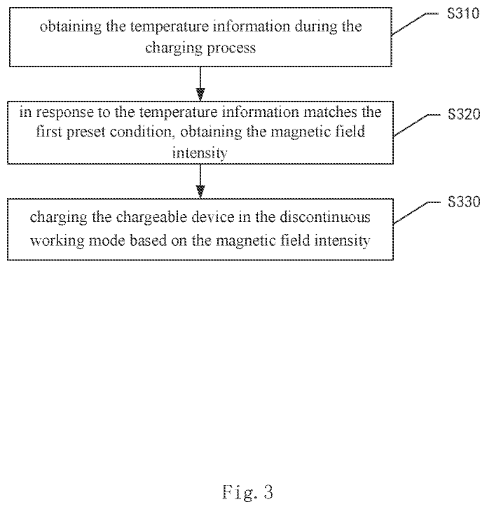

FIG. 3 is the third flow chart of the wireless charging control method according to the embodiments of the present disclosure. As shown in FIG. 3, the wireless charging control method of the present embodiment includes the following steps.

In step S310, the temperature information during the charging process is obtained.

In step S320, in response to the temperature information matches the first preset condition, the magnetic field intensity is obtained.

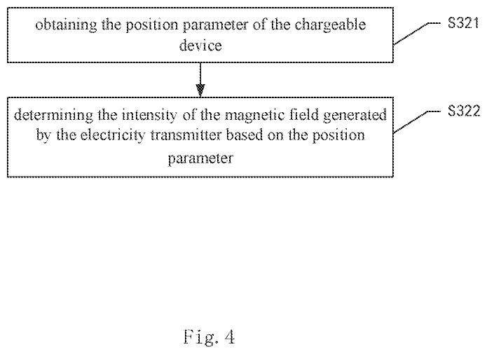

Optionally, as shown in FIG. 4, in the present embodiment, the magnetic field intensity is determined based on the following steps.

In step S321, a position parameter of the chargeable device is obtained, which are determined based on the coil quality factor of the electricity transmitter.

Optionally, in the present embodiment, after the charging process starts, the electricity transmitter generates a magnetic field with preset intensity to charge the chargeable device, until the temperature information matches the first preset condition, and the position parameter of the chargeable device are obtained.

The coil quality factor is equal to the ratio of the inductive reactance to the impedance when the coil is operated under AC voltage with a certain frequency, and reflects the power loss of the coil. The closer the chargeable device is next to the electricity transmitter, the greater the power loss of the electricity transmitting coil and the lower the coil quality factor. When the temperature information is detected to meet the first preset condition, the magnetic field intensity does not change. Therefore, the change of the coil quality factor can reflect the distance or change of the distance between the receiving coil and the transmitting coil, that is, the distance or change of the distance between the chargeable device and the electricity transmitter. Thereof, in the present embodiment, the position parameter of the chargeable device is determined based on the coil quality factor of the power transmitting coil in the electricity transmitter.

In step S322, the intensity of the magnetic field generated by the electricity transmitter is determined based on the position parameter.

Optionally, the distance between the electricity transmitter and the chargeable device at the beginning of the charging process is determined as the initial distance in the present embodiment.

If the position parameter of the chargeable device haven't changed, it is indicated that the distance between the chargeable device and the electricity transmitter remains at the initial distance after the temperature information matches the first preset condition. At the time, there is no need to adjust the intensity of the magnetic field generated by the electricity transmitter, and only need to maintain the magnetic field intensity as the preset intensity of the magnetic field.

When the position parameter of the chargeable device has changed, it is indicated that the distance between the chargeable device and the electricity transmitter changes after the temperature information matches the first preset condition. Then, the intensity of the magnetic field generated by the electricity transmitter needs to be adjusted according to the position parameter of the chargeable device to improve the charging speed of the chargeable device.

Optionally, the magnetic field intensity adjusted in the present embodiment is the intensity of the magnetic field generated by the electricity transmitter when the chargeable device may achieve the best charging effect at the current position parameter.

Furthermore, in the present embodiment, the intensity of the magnetic field generated by the electricity transmitter is adjusted by modifying the current flow through the electricity transmitting coil or the voltage of the electricity transmitting coil.

In step S330, the chargeable device is charged in the discontinuous mode based on the magnetic field intensity.

In the present embodiment, in the discontinuous mode, the electricity transmitter is controlled to generate the magnetic field intensity corresponding to the current position parameter during the first charging time period of each charging cycle, so as to charge the chargeable device and energy storage element. In the second charging time period of each charging cycle, the battery of the chargeable device is charged by the energy storage element.

The embodiments of the present disclosure determine the coil power factor of the chargeable device based on the coil power factor of the receiving coil in the chargeable device, determine the intensity of the magnetic field generated by the electricity transmitter based on distance or the change of the distance between the receiving coil in the chargeable device and the transmitting coil in the electricity transmitter, and charge the chargeable device and the electricity storage elements according to the determined magnetic field intensity, in order to accelerate the charging speed of the chargeable device and ensure that the electricity storage elements in the chargeable device can store enough energy to maintain the charging state of the chargeable device. At the same time, in the first charging time of each charging cycle, the electricity transmitter is controlled to generate a magnetic field to charge the chargeable device. At the second charging time of each charging cycle, the energy storage capacitor charges the chargeable device. Therefore, cooling process can be accelerated in the charging process, which can improve the charging efficiency of the chargeable device and improving the charging experience of users.

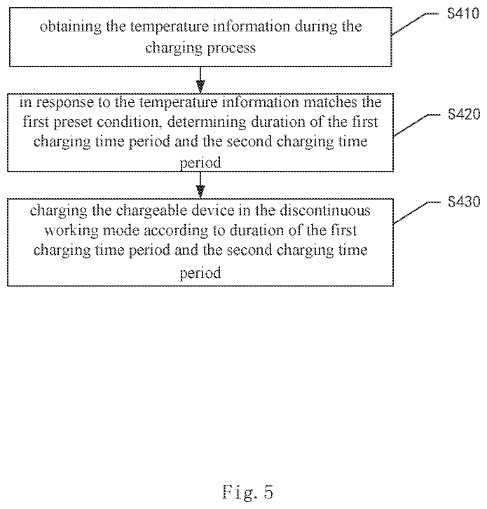

FIG. 5 is the fourth flow chart of the wireless charging control method according to the embodiments of the present disclosure. As shown in FIG. 5, the wireless charging control method of the present embodiment includes the following steps:

In step S410, the temperature information is obtained during the charging process.

The temperature information obtained in the charging process in the present embodiment is consistent with the previous embodiment and will not be described here.

In step S420, in response to the temperature information matches the first preset condition, the first charging time and the second charging time is determined.

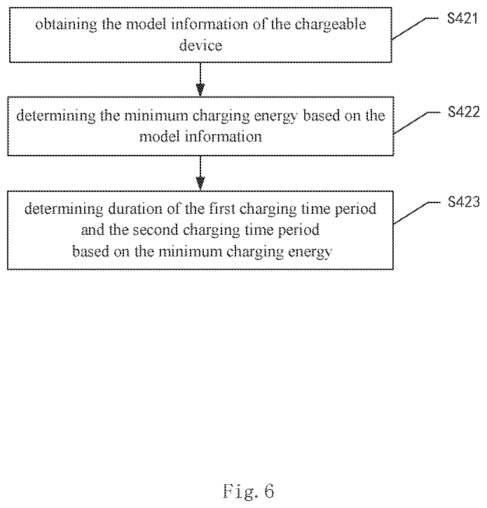

Optionally, as shown in FIG. 6, the following steps are included in the present embodiment to determine the first charging time and the second charging time.

In step S421, the model information of the chargeable device is obtained.

In step S422, the minimum charging energy is determined based on the model information. The minimum charging energy represents electricity parameter to maintain the chargeable device is being charged.

In the present embodiment, the model information of the chargeable device may be determined based on communication massages between the chargeable device and the electricity transmitter. The model information of the chargeable device corresponding to the minimum charging energy. The minimum charging energy of chargeable device varies with the model information of chargeable device.

In the present embodiment, the energy stored by the electricity storage element in the chargeable device is greater than or equal to a value corresponding to the minimum charging energy.

In step S423, the duration of first charging time period and the duration of the second charging time period are determined based on the minimum charging energy.

In the present embodiment, the duration of the first charging time period is related to the amount of energy stored by the energy storage element in the chargeable device and the charging rate of the energy storage element. The amount of energy stored by the energy storage element is determined according to the minimum charging energy, and the charging rate of the energy storage element is mainly determined by the magnetic field intensity. The greater intensity of the magnetic field generated by the electricity transmitter is, the faster the charging rate of the electricity storage element is. Thereof, in order to ensure that the energy stored in the electricity storage element is enough to maintain the charging state of the chargeable device and accelerate the charging process of the chargeable device, the first charging time in the present embodiment is determined by both the minimum charging energy and the intensity of the magnetic field generated by the electricity transmitter.

Furthermore, to determining the duration of the first charging time period in the present embodiment, the threshold of the first charging time period is firstly determined according to the minimum charging energy and the intensity of the magnetic field generated by the electricity transmitter. The duration of the first charging time period is determined according to the threshold of the first charging time. The first charging time threshold represents time for charging the energy storage element to a state with the minimum charging energy under the present magnetic field intensity. The duration corresponding to the first charging time is greater than or equal to the first charging time threshold.

In the present embodiment, in the second charging time period, the energy storage element has already stored a certain capacity of energy, and the chargeable device is charged by the energy storage element. Therefore, the duration corresponding to the second charging time period is mainly determined by the charging rate the electricity storage element charging the chargeable device and the minimum charging energy, while the charging rate the electricity storage element charging the chargeable device is determined by the electricity storage element itself. Thereof, the second charging time is determined according to the minimum charging energy in the present embodiment to ensure that the heat dissipated during the second charging time of each charging cycle is greater than the heat generated during the first charging time, thus reducing the charging temperature during the charging process.

Furthermore, to determine the duration of the second charging time period, the threshold of the second charging time is firstly determined according to the minimum charging energy. And then, the duration of the second charging time period is determined according to the second charging time threshold. The second charging time threshold represents time that the power corresponding to the minimum charging energy can charge the chargeable device. The duration of the second charging time period is less than or equal to the second charging time threshold.

In step S430, the electricity transmitter is controlled to work in the discontinuous mode according to the duration of the first charging time period and the duration of the second charging time period. In the present embodiment, in the discontinuous mode, the electricity transmitter is controlled to charge the chargeable device during the first charging time period of each charging cycle, and the energy storage element is utilized to charge the chargeable device during the second charging time period of each charging cycle.

Furthermore, the present embodiment controls the electricity transmitter to charge the electricity storage element in the first charging time period of each charging cycle, and to stop charging the chargeable device during second charging time period of each charging cycle to make an energy storage element in the chargeable device discharge to a battery.

It should be understood that in the present embodiment, the first charging time period and the second charging time period may be determined by advance test according to the charging cycle, the charging rate (determined by the intensity of magnetic field), the maximum energy storage and the discharging rate (determined by the minimum charging energy) of the energy storage element. They can also be determined in the actual process of charging according to the actual charging status in real time adjustment, there is no restriction in the present embodiments. Optionally, in the present embodiment, users can calculate and determine the duration of the first charging time period and the second charging time period according to the above mothed. Or, the ratio of the first charging time and the second charging time may be determined according to the magnetic field intensity, the maximum energy storage and the minimum charging energy of the energy storage element, then determine the duration of the first charging time period and the second charging time period according to the charging cycle. There is no restriction in the present embodiments.

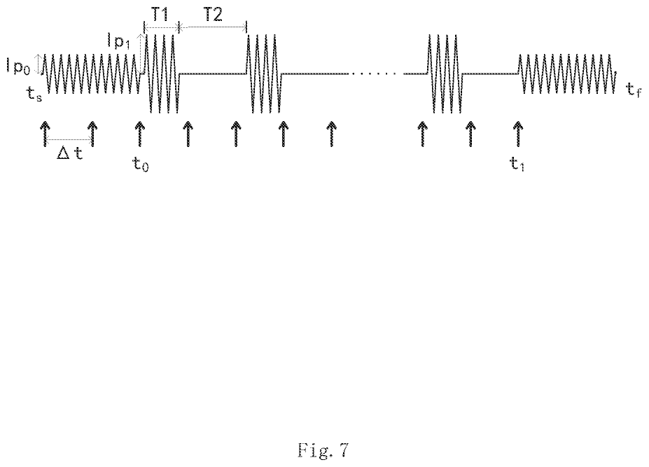

FIG. 7 is a schematic diagram of charging process for the chargeable device according to the embodiments of the present disclosure. As shown in FIG. 7, tₛ refers to the beginning of the charging process, end t_{f} refers to the ending of the charging, Δt refers to the time interval to obtain the temperature information, T1 refers to the first charging time, T2 refers to the second charging time, to refers to the moment that the temperature information matches the first preset conditions, t₁ refers to the moment that the temperature information doesn't match the first preset conditions, Ip₀ refers to the preset magnetic field intensity, and Ip₁ refers to the adjusted magnetic field intensity.

Specifically, the charging process starts at the moment tₛ, the chargeable device is being charged based on the preset magnetic field intensity Ip₀, and the temperature information is obtained at every time interval Δt. If the temperature information doesn't match the first preset conditions, the continuous mode is adopted for the chargeable device charging, in which the electricity transmitter is controlled to produce magnetic field at intensity Ip₀ to charge the chargeable device. At time to, when the temperature information obtained matches the first preset condition, the position parameter is obtained, and the intensity of the magnetic field generated by the electricity transmitter is determined according to the position parameter. If the position parameter at the time indicates that the chargeable device and the electricity transmitter remains the preset distance therebetween, the magnetic field intensity is determined to be Ip₀. If the position parameter at the time indicates that the distance between the chargeable device and the electricity transmitter changes and no longer stays at the preset distance, control the intensity of the magnetic field generated by the electricity transmitter to adjust from Ip₀ to Ip₁. After determining the magnetic field strength stays at Ip₁, the model information of the chargeable device is obtained. The minimum charging energy as Q is determined according to the model information. The duration of the first charging time period T1 and the duration of the second charging time period T2 are determined respectively according to the minimum charging energy Q. The chargeable device is charged in the discontinuous mode according to the duration T1 and T2. Until moment t₁, the temperature information obtained in the charging process no longer matches the first preset condition, indicating that the temperature in the charging process has dropped to the normal level, then the electricity transmitter is controlled to restore to the continuous mode and continues to charge the chargeable device until charging process of the chargeable device is completed at moment t_{f}.

Optionally, in the present embodiment, the charging process in the discontinuous mode includes multiple charging cycles. Assuming that each charging cycle is set to is, the time ratio between the first charging time period T1 and the second charging time period T2 determined by the magnetic field intensity, minimum charging energy and the storage capacity of the energy storage element is 1: 4, resulting in that the first charging time T1 is set to be 200 ms, and the second charging time T2 is set to be 800 ms.

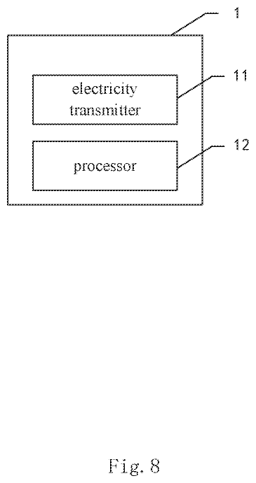

FIG. 8 is a schematic diagram of the wireless charger according to the embodiments of the present disclosure. As shown in FIG. 8, the wireless charger 1 of the present embodiment includes an electricity transmitter 11 and a processor 12. The electricity transmitter 11 is configured to generate a magnetic field to charge the chargeable device. Processor 12 is configured to perform the method described in any of the embodiments above.

Optionally, the processor in the present embodiment is configured to obtain the temperature information during charging process, in response to the temperature information matches the first preset condition, charge the chargeable device in the discontinuous mode. In the discontinuous mode, electricity transmitter is controlled to charge the chargeable device during a first charging time period of each charging cycle, and to stop charging the chargeable device during second charging time period of each charging cycle to make an energy storage element in the chargeable device discharge to a battery. Therefore, through the electricity transmitter and energy storage component alternately charge the chargeable device, the continuous generation of magnetic field of the electricity transmitter during the charging process can be avoided, so as to reduce the power consumption causing by the magnetic sensation, increase the cooling speed of the electricity transmitter and the chargeable device, thus reduce the charging temperature of the electricity transmitter and the chargeable device. At the same time, it can reduce the wake-up times of the chargeable device during the charging process and avoid damage to the chargeable device caused by frequent charging interruption, which can improve the user experience.

Optionally, the processor in the present embodiment is configured to obtain the temperature information at every interval time, which includes charging power and/or charging temperature obtain by sampling, to determine whether the temperature information matches the first preset conditions, in response to temperature information matches the first preset conditions, and to charge the chargeable device in the discontinuous work mode. In response to the temperature information doesn't match the first preset condition, the continuous mode is adopted to charge the chargeable device. In the discontinuous mode, electricity transmitter is controlled to charge the chargeable device during a first charging time period of each charging cycle, and to stop charging the chargeable device during second charging time period of each charging cycle to make an energy storage element in the chargeable device discharge to a battery. When the chargeable device is charged in continuous mode, the electricity transmitter is controlled to charge the chargeable device and the electricity storage element disposed in the chargeable device.

Thus, the performance of the electricity transmitter can be increased, facilitating the charging of the electricity storage element. At the same time, the heat generation can be reduced based on the premise that the constantly charging of the chargeable device can be maintained, which speeds up the cooling of chargeable device and the electricity transmitter, reduces the temperature, and decreases the wake-up times of the chargeable device and message-sending times to the user at the same time, so as to simplify the charging process, avoid damage to the chargeable device, improve the charging efficiency of the chargeable device and the user experience. In addition, when the over-temperature appears in the charging process, and the discontinuous work mode need to be adopted for charging, the chargeable device can be controlled into the second charging time firstly, and charging by the energy stored in the energy storage capacitor, so as to reduce the process of charging the energy storage capacitor by the electricity transmitter, further speed up the cooling process, and improve the charging efficiency of the chargeable device.

Optionally, the processor of the present embodiment is configured to obtain the temperature information during charging process, in response to the temperature information matches the first preset condition, to determine the magnetic field intensity during the charging progress, to determine the duration of the first charging time period and the second charging time period, and charge the chargeable device in the discontinuous mode. While determine the magnetic field intensity, the processor is configured to obtain the position parameter of the chargeable device, and determine the intensity of the magnetic field generated by the electricity transmitter according to the position parameter. While determine the first charging time and the second charging time, the processor is configured to obtain the model information of the chargeable device, determine the minimum charging energy according to the model information, and determine the first charging time and the second charging time according to the minimum charging energy.

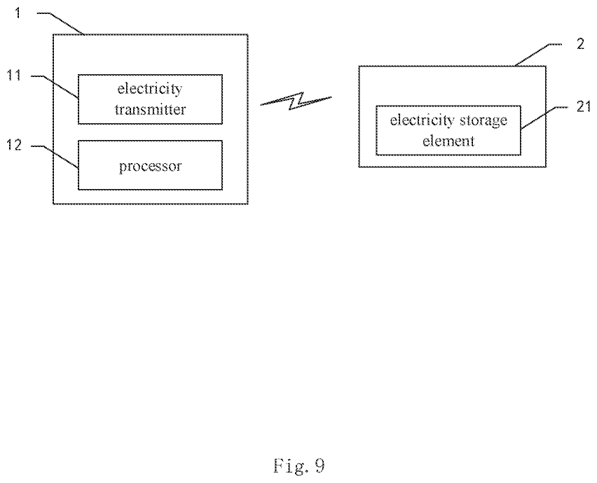

FIG. 9 is a schematic diagram of the wireless charging system according to the embodiments of the present disclosure. As shown in FIG. 9, the wireless charging system of the present embodiment includes wireless charger 1 and chargeable device 2. The wireless charger 1 includes electricity transmitter 11 and processor 12. The electricity transmitter 11 is configured to generate a magnetic field to charge the chargeable device. The processor 12 is configured to perform the method described in any of the embodiments above. The chargeable device 2 includes electricity storage element 21, which is configured to be charged at the first charging time and charge the chargeable device 2 at the second charging time.

Disclosed in embodiments of the present disclosure are a wireless charging control method and a wireless charging system. An electricity transmitter is controlled to charge a chargeable device in the discontinuous mode in response to the temperature information matches the first preset condition. In the discontinuous mode, electricity transmitter is controlled to charge the chargeable device during first charging time period of each charging cycle, and to stop charging the chargeable device during second charging time period of each charging cycle to let an energy storage element in the chargeable device discharge to a battery. Thus, it is possible to reduce the power consumption caused by magnetic induction in the wireless charging process, to lower the temperature of the electricity transmitter and the chargeable device, and to reduce the wake-up times of the chargeable device during the charging process.

The descriptions above are only preferred embodiments of the present disclosure, but are not intended to limit the present disclosure. For a person skilled in the art, the present disclosure may have various changes and variations. Any modifications, equivalent substitutions, improvements and the like made within the spirit and principles of the present disclosure are all intended to be concluded in the protection scope of the present disclosure.

I/We claim:

1. A wireless charging control method, comprising:
obtaining temperature information during charging process; and
charging a chargeable device in discontinuous mode in response to the temperature information matches first preset condition;
wherein, in the discontinuous mode, electricity transmitter is controlled to charge the chargeable device during first charging time period of each charging cycle, and to stop charging the chargeable device during second charging time period of each charging cycle to make an energy storage element in the chargeable device discharge to a battery.

2. The wireless charging control method according to claim 1, wherein the method further comprising:
in response to the temperature information doesn't match the first preset condition, charging the chargeable device in continuous mode, in which the electricity transmitter is controlled to charge the chargeable device continuously.

3. The wireless charging control method according to claim 1, wherein the method further comprising:
obtaining position parameter of the chargeable device, which are determined based on the coil quality factor of the electricity transmitter; and
determining intensity of magnetic field generated by the electricity transmitter based on the position parameter.

4. The wireless charging control method according to claim 1, wherein the method further comprising:
determining the first charging time and the second charging time.

5. The wireless charging control method according to claim 4, wherein the determining the first charging time and the second charging time comprising:
obtaining model information of the chargeable device;
determining minimum charging energy based on the model information; and
determining the duration of the first charging time period and the duration of the second charging time period based on the minimum charging energy;
wherein, the minimum charging energy represents quantity of electrical energy to maintain the charging state of the chargeable device.

6. The wireless charging control method according to claim 4, wherein the determine the duration of the first charging time period and the duration of the second charging time period further comprising:
determining a first charging time threshold based on minimum charging energy and intensity of magnetic field generated by the electricity transmitter;
determining the duration of the first charging time period based on the first charging time threshold;
determining a second charging time threshold based on the minimum charging energy; and
determining the second charging time based on the second charging time threshold;
wherein, the minimum charging energy represents quantity of electric charge to maintain the charging state of the chargeable device; the first charging time threshold represents time for charging the energy storage element to a state with the minimum charging energy under the present magnetic field intensity; the second charging time threshold represents time for discharging the energy storage element to maintain the chargeable device in charging state.

7. The wireless charging control method according to claim 1, wherein, the energy storage element is disposed in the chargeable device.

8. The wireless charging control method according to claim 1, wherein obtaining temperature information during charging process comprising:
obtaining the temperature information at preset intervals.

9. The wireless charging control method according to claim 1, wherein the temperature information includes charging power and/or charging temperature obtain by sampling;
the charging temperature represents the temperature of the electricity transmitter and/or the chargeable device collected during charging.

10. The wireless charging control method according to claim 9, wherein the charging power is transmitted from the chargeable device to the electricity transmitter through a message.

11. The wireless charging control method according to claim 9, wherein the first preset condition is that the charging power is less than or equal to a preset power value or the charging temperature is greater than or equal to a preset temperature value.

12. A wireless charger, comprising:
an electricity transmitter, configured to generate magnetic field to charge a chargeable device; and
a processor, configured to perform operations comprising:
obtaining temperature information during charging process; and
charging a chargeable device in discontinuous mode in response to the temperature information matches first preset condition;
wherein, in the discontinuous mode, electricity transmitter is controlled to charge the chargeable device during a first charging time period of each charging cycle, and to stop charging the chargeable device during second charging time period of each charging cycle to make an energy storage element in the chargeable device discharge to a battery.

13. A wireless charging system, comprising:
a wireless charger, comprising an electricity transmitter and a processor, the electricity transmitter is configured to generate magnetic field for charging a chargeable device, the processor is configured to perform operations comprising:
obtaining temperature information during charging process; and
charging a chargeable device in discontinuous mode in response to the temperature information matches first preset condition;
wherein, in the discontinuous mode, electricity transmitter is controlled to charge the chargeable device during a first charging time period of each charging cycle, and to stop charging the chargeable device during second charging time period of each charging cycle to make an energy storage element in the chargeable device discharge to a battery;
the chargeable device, comprising an energy storage element configured to be charged at a first charging time period and discharge to a battery at a second charging time period.

14. The wireless charging system according to claim 13, wherein the processor is further configured to perform operation comprising:
in response to the temperature information doesn't match the first preset condition, charging the chargeable device in continuous mode, in which the electricity transmitter is controlled to charge the chargeable device continuously.

15. The wireless charging system according to claim 13, wherein the processor is further configured to perform operations comprising:
obtaining position parameter of the chargeable device, which are determined based on the coil quality factor of the electricity transmitter; and
determining intensity of magnetic field generated by the electricity transmitter based on the position parameter.

16. The wireless charging system according to claim 13, wherein the processor is further configured to perform operation comprising:
determining the duration of the first charging time period and the duration of the second charging time period.

17. The wireless charging system according to claim 16, wherein the processor is further configured to perform operations comprising:
obtaining model information of the chargeable device;
determining minimum charging energy based on the model information; and
determining the duration of the first charging time period and the duration of the second charging time period based on the minimum charging energy;
wherein, the minimum charging energy represents quantity of electric charge to maintain the charging state of the chargeable device.

18. The wireless charging system according to claim 16, wherein the processor is further configured to perform operations comprising:
determining a first charging time threshold based on minimum charging energy and intensity of magnetic field generated by the electricity transmitter;
determining the duration of the first charging time period based on the first charging time threshold;
determining a second charging time threshold based on the minimum charging energy; and
determining the second charging time based on the second charging time threshold;
wherein, the minimum charging energy represents quantity of electric charge to maintain the charging state of the chargeable device; the first charging time threshold represents time for charging the energy storage element to a state with the minimum charging energy under the present magnetic field intensity; the second charging time threshold represents time for discharging the energy storage element to maintain the chargeable device in charging state.

19. The wireless charging system according to claim 13, wherein the processor is further configured to perform operation comprising:
obtaining the temperature information at preset intervals.

20. The wireless charging system according to claim 13, wherein the temperature information includes charging power and/or charging temperature obtain by sampling;
the charging temperature represents the temperature of the electricity transmitter and/or the chargeable device collected during charging.
